(19) United States
(12) Patent Application Publication
(10) Pub. No.: US 2026/0050880 A1
(43) Pub. Date: Feb. 19, 2026

(54) Method and Apparatus for the Efficient Delivery of Shipments of Different Sizes Into a Compartment System

(71) Applicant: Jörg Salomon, Bonn (DE)

(72) Inventor: Jörg Salomon, Bonn (DE)

(73) Assignee: Deutsche Post AG, Bonn (DE)

(21) Appl. No.: 19/299,528

(22) Filed: Aug. 14, 2025

(30) Foreign Application Priority Data
Aug. 16, 2024 (DE) 10 2024 123 411.3

(51) Int. Cl. G06Q 10/0836

(52) U.S. Cl. CPC G06Q 10/08365

(57) ABSTRACT

A method is disclosed, inter alia, performed by a first apparatus or by a component thereof. The first apparatus comprises a plurality of register compartments. The method includes receiving a shipment, in particular a letter shipment. The method includes checking whether the shipment is to be placed in a register compartment of the plurality of register compartments. The method includes accepting the shipment into a register compartment if the checking has concluded that the shipment is to be accepted into a register compartment of the plurality of register compartments and rejecting the shipment if the checking has concluded that the shipment should not be accepted into a register compartment of the plurality of register compartments. In addition, corresponding apparatuses, systems and computer programs for the respective performance and/or control of the disclosed method are disclosed.

### CROSS-REFERENCE TO RELATED PATENT APPLICATION

This patent application claims the benefit of priority to German Patent Application No. 10 2024 123 411.3 filed Aug. 16, 2024, the entire teachings and disclosures are incorporated herein by reference thereto.

### FIELD

Exemplary embodiments of the invention relate to methods, apparatuses, systems and computer programs for delivering shipments, in particular letter shipments, to register compartments of an apparatus, wherein the apparatus is in particular a compartment system which is also suitable for accepting parcel shipments.

### BACKGROUND

Letter shipments are usually delivered on site to a letterbox at the recipient's address. Alternatively, items can be delivered to a mailbox. A mailbox is a lockable compartment which is secured against third-party access, can usually be rented by the recipient from a delivery company or its partners for a certain period of time and is then permanently assigned to the recipient for this period. Mailboxes are usually located in mailbox facilities in the branches of the delivery companies or their partners. For example, the recipient has access to the mailbox they have rented by means of a key or an access code. For example, mailboxes are useful for receiving business mail, or for recipients who rarely have the opportunity to empty a letterbox.

Compartment systems are used in a variety of ways, for example, in the form of locker or parcel box systems. An example of a parcel box system is the packing station of the applicant, to which a recipient can have shipments delivered. The shipment is placed by the agent in a compartment at a packing station located near the recipient and/or previously designated by the recipient, the compartment is closed and the recipient is notified accordingly.

### SUMMARY OF SOME EXEMPLARY EMBODIMENTS OF THE INVENTION

Compartment systems have so far been primarily intended for the delivery and/or collection of parcel shipments. In order to also enable the recipients of mailbox shipments (mailbox users) to enjoy the advantages of a compartment system, such as unlimited access regardless of branch opening hours, a plurality of pick-up locations and/or the simultaneous collection of letter and parcel shipments, the possibility of delivering mailbox shipments to compartment systems is desirable. In particular, efficient use of the available space is desirable. The delivery of individual letter shipments to the compartments of the compartment systems configured for parcel shipments would significantly reduce the capacity of the compartment system and is therefore not desirable. In addition, the number of letter shipments often varies greatly for a particular mailbox user and also between different mailbox users, so that a dynamic delivery option is desirable, which does not require an individual mailbox to be available for each mailbox user at all times. In addition, it is desirable to offer people who do not rent a mailbox the possibility to have letter shipments delivered outside of their recipient address.

The object of the present invention is to overcome one or more of the disadvantages described above and/or to obtain one or more of the advantages described above and/or to achieve one or more of the desired improvements described above.

According to an exemplary aspect of the invention, a method is disclosed, comprising: receiving a shipment; checking whether the shipment is to be accepted into a register compartment of the plurality of register compartments; accepting the shipment into a register compartment if the checking has concluded that the shipment is to be accepted into a register compartment of the plurality of register compartments; and rejecting the shipment if the checking has concluded that the shipment should not be accepted into a register compartment of the plurality of register compartments. The method is performed, for example, by a first apparatus or a component of the first apparatus. The shipment may, for example, be a letter shipment. The method may also comprise issuing the shipment to a person who has successfully authenticated themself to the first apparatus.

The present application also discloses the following exemplary embodiments:
An apparatus comprising means for performing and/or controlling the method, wherein the apparatus is the first apparatus or the component thereof. Either all steps of the method can be controlled, or all steps of the method can be performed, or one or more steps can be controlled and one or more steps can be performed.
An apparatus comprising at least one processor and at least one memory which comprises program code, wherein the memory and the program code are configured to cause a or the apparatus having the at least one processor to at least perform and/or to control the method. Either all steps of the method can be controlled, or all steps of the method can be performed, or one or more steps can be controlled and one or more steps can be performed.
A use of one of these apparatuses to deposit a shipment for a person, for example in the first apparatus, and to allow the person to gain access to that shipment, for example by issuing the shipment.
A computer program, comprising program instructions that cause a processor to execute and/or control at least the following steps when the computer program is running on the processor: receiving a shipment (in particular a letter shipment) on a first apparatus comprising a plurality of register compartments; checking whether the shipment is to be placed in a register compartment of the plurality of register compartments; accepting the shipment into a register compartment if the checking has concluded that the shipment is to be accepted into a register compartment of the plurality of register compartments; and rejecting the shipment if the checking has concluded that the shipment should not be accepted into a register compartment of the plurality of register compartments. A processor in this specification shall be understood to include control units, microprocessors, microcontrol units such as microcontrollers, digital signal processors (DSP), application-specific integrated circuits (ASICs) or field-programmable gate arrays (FPGAs). Either all steps of the method can be controlled, or all steps of the method can be performed, or one or more steps can be controlled and one or more steps can be performed. The computer program can be distributable, for example, over a network such as the Internet, a telephone or mobile communication network, and/or a local network. The computer program can be, at least in part, software and/or firmware of a processor. It can also be implemented at least partially as hardware. The computer program may be stored, for example, on a computer-readable storage medium, e.g. a magnetic, electrical, optical and/or other type of storage medium. For example, the storage medium may be part of the processor, such as a (non-volatile or volatile) program memory of the processor or a portion of it. For example, the storage medium may be a material or physical storage medium.

Further advantageous exemplary embodiments of the invention are to be found in the following detailed description of some exemplary embodiments of the present invention, in particular in conjunction with the figures. However, the figures accompanying the application are intended only for the purpose of clarification, rather than determining the scope of protection of the invention. The accompanying drawings are not necessarily true to scale and are merely intended to reflect the general concept of the invention in an exemplary way. In particular, features contained in the figures should absolutely not be considered a necessary component of the present invention.

### BRIEF DESCRIPTION OF THE DRAWINGS

In the figures:

FIG. 1a shows a schematic illustration of an exemplary embodiment of an apparatus according to the present invention;

FIG. 1b shows a schematic illustration of an exemplary embodiment of an apparatus according to the present invention;

FIG. 2 shows a schematic illustration of an exemplary embodiment of a component of the apparatus according to the present invention;

FIG. 3 shows a flow diagram of an exemplary embodiment of a method according to the present invention;

FIG. 4 shows a schematic illustration of an exemplary embodiment of a method according to the present invention.

FIG. 5 shows a schematic illustration of an exemplary embodiment of a partial aspect of a method according to the present invention;

FIG. 6 shows a schematic illustration of an exemplary embodiment of an apparatus according to the present invention.

### DETAILED DESCRIPTION OF SOME EXEMPLARY EMBODIMENTS OF THE INVENTION

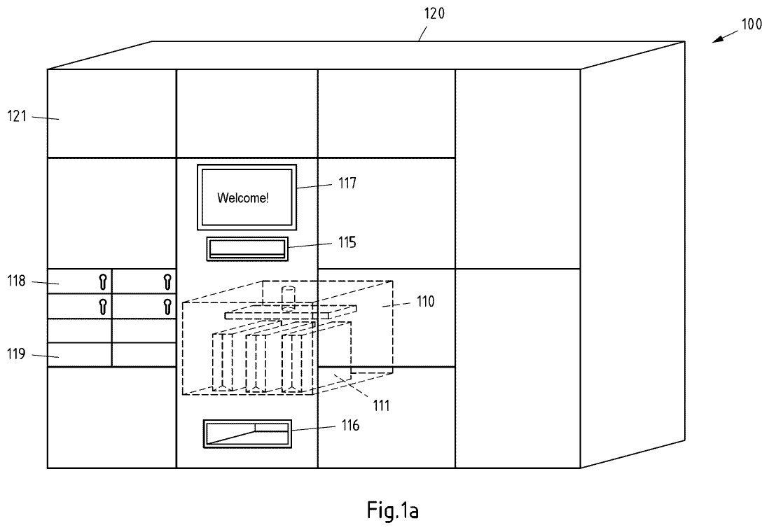

FIG. 1a and FIG. 1b show an exemplary first apparatus 100 according to different exemplary embodiments of the present invention.

In FIG. 1a, the first apparatus 100 comprises a compartment system 120 with multiple compartments 122 and a register system 110 with a plurality of register compartments 111, which is located, for example, in one of the compartments 122. In FIG. 1b, the first apparatus 100 comprises a compartment system 120 and a system 130 which is separate from the compartment system 120 and in which the register system 110 having a plurality of register compartments 111 is located. For example, the system 130 and the compartment system 120 can be separated spatially as shown, but for example also (only) systematically (e.g. by separately running computer programs, separate communication or user interfaces, and/or separate data storage means). In other exemplary embodiments, the first apparatus does not have to include all the components of the (compartment) systems 120 and 130 shown, e.g., the system 130 and not the compartment system 120, or may only include some components of the system 130.

As shown in FIG. 1a and FIG. 1b, the first apparatus 100 comprises a plurality of register compartments 111. Each of the register compartments 111 is provided for receiving at least one shipment, in particular a letter shipment. For example, letter shipments include shipments in standard, compact, large or maxi formats from the Deutsche Post and/or similar formats from other postal service providers. Letter shipments may also include book shipments and/or bag-packed shipments. Letter shipments may also be characterized by the fact that they are usually delivered by letter delivery companies (and not by parcel services). Alternatively or in addition, shipments can be categorized as letter shipments, for example, based on their dimensions. For example, letter shipments may include shipments with a smallest dimension of less than a first maximum dimension (e.g. a height of less than 1 cm, 2 cm or 5 cm) and/or with a largest dimension of less than a second maximum dimension (e.g. a length of less than 25 cm, 30 cm or 40 cm) and/or having a sum of two or three dimensions of less than a third maximum dimension (e.g. sum of length, width and height of less than 40 cm, 50 cm or 60 cm) and/or with a minimum dimension of less than the longest dimension or than both remaining dimensions by a minimum factor (e.g. a height that is less than the length, width and/or sum of length and width by a factor of 2, 5 or 10). Alternatively or in addition, letter shipments may include only shipments up to a maximum weight, for example up to 50 g, 500 g or 1000 g.

In exemplary embodiments, at least one register compartment of the plurality of register compartments 111, for example only one register compartment, some register compartments or all register compartments 111, can be configured to store multiple shipments at the same time, in particular multiple shipments associated with the same recipient or the same group of recipients. In the following, a recipient may in all cases also represent a group of recipients, such as a group of employees from the same company. The register compartments 111 are not publicly accessible and are located, for example, inside the first apparatus 100. For receiving and outputting shipments into a register compartment 111, the first apparatus 100 comprises, for example, an input point 115 and an output point 116, but the input point 115 and the output point 116 can also be formed, for example, by a common unit.

In exemplary embodiments, the register compartments 111 may be part of a register system 110. For this purpose, the first apparatus 100 may also comprise a register system 110. In some of these exemplary embodiments, the register system 110 may be configured to perform the accepting of the shipment into the register compartment 111 and/or to perform the issuing of the shipment. In exemplary embodiments, the register compartments 111 can be arranged to be movable in the register system 110, in particular rotatable about an axis. In some of these exemplary embodiments, the register compartments 111 in the register system 110 are movable along a closed, in particular oval trajectory, for example, by the register compartments being arranged on a circulating belt. The accepting of shipments is then achieved, for example, by moving the register compartment 111, into which the shipment is to be accepted, such that it is located below a receiving opening. For example, the register compartments 111 may be open at the top or at the side, or alternatively, they may have a mechanism, for example, that opens the register compartments 111 when shipments are to be accepted. For issuing shipments, the register compartments 111 can be moved, for example, over an output opening and, for example, opened downwards or rotated. Alternatively, the shipments can be removed from the register compartments 111, for example, by means of a gripper mechanism, if these compartments are open at the top or at the side. Alternatively, the register compartments 111 can be arranged in a shelving system, for example horizontally or vertically. The accepting or issuing of shipments is then achieved, for example, by means of a horizontally or vertically movable shelf and sliding or rolling apparatuses in the shelf and the register compartments 111, which transport the shipment from the shelf to the register compartment 111 or the other way round. In exemplary embodiments, at least one of the register compartments 111 may be configured to change its size. For example, the register compartments 111 can be individually adapted to the number and size of shipments to be accepted into the register compartments 111. In exemplary embodiments, at least one of the register compartments can have a storage size and an input size, wherein for inputting a shipment into the at least one register compartment and/or outputting a shipment from the at least one register compartment, the register compartment is enlarged from the storage size to the input size and after the input and/or output is reduced to the storage size again.

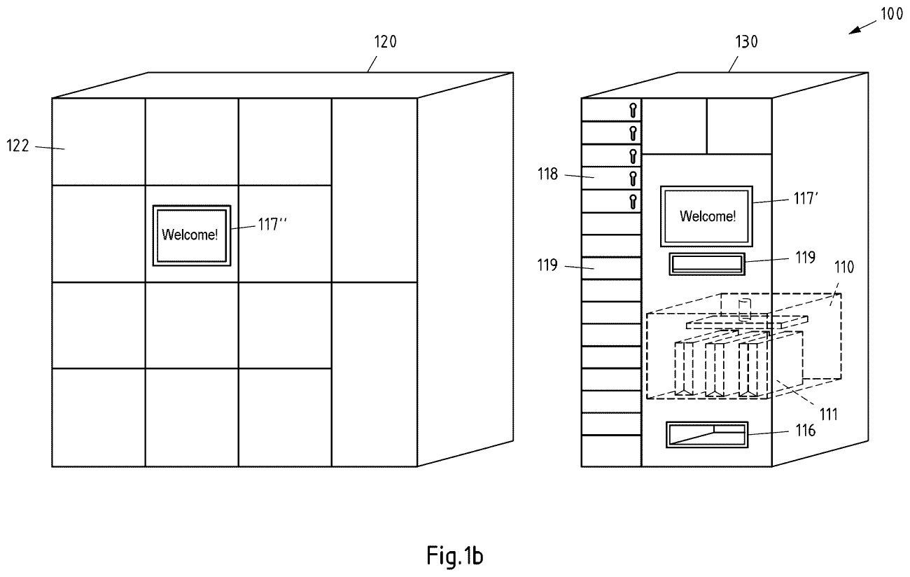

The register system 110 is shown schematically in FIG. 2 in an exemplary embodiment. The register compartments 201, 202 are arranged around an axis of rotation 207, which can be rotated in both directions, for example. To accept one or more shipments 205, the register compartment 201 is moved by a rotation along the axis of rotation 207 under a receiving opening 203. For example, the receiving opening 203 may be permanently open, so that the shipments 205 which are in front of the receiving opening 203 fall into the register compartment 201. Alternatively, the receiving opening 203 can be opened to accept the shipments 205 into the register compartment 201, for example, by a flap mechanism as shown or alternatively by a sliding mechanism, for example after the register compartment 201 has been moved under the receiving opening 203. Alternatively or in addition, for example, the register compartment 201 can be opened by, for example, a flap or sliding mechanism. After the shipment 205 has been input into the register compartment, the receiving opening 203 and/or the register compartment 201 can be closed again. Subsequently, for example, another register compartment can be moved under the receiving opening 203 by a rotation along the axis of rotation 207 for accepting further shipments, or a register compartment can be moved over the output opening 204 for issuing shipments. For issuing one or more shipments 206, for example, the register compartment 202 can be moved over the output opening 204 by a rotation along the axis of rotation 207. The output opening 204 and/or the register compartment 202 can then be opened, for example, by a flap or sliding mechanism, for example as illustrated by opening a flap of the output opening 204, so that the shipments 206 are output from the register compartment 202, for example, by falling out of the register compartment 202. The output opening and/or the register drawer can then be closed, so that the register system 110 is ready to accept or issue further shipments.

In exemplary embodiments in which the received shipment is a letter shipment, the first apparatus 100 can further comprise multiple compartments, of which at least some compartments 118, 119, 122 are configured for accepting letter shipments. Each of these compartments 118, 119, 122 is intended to accept one or more letter shipments, e.g. for an individual recipient (similar to or exactly as in conventional mailboxes). Multiple compartments 118, 119, 122 can also be assigned to an individual recipient. Each of these compartments 118, 119, 122 may be locked or closed when the system is in the initial state. For example, some compartments 118 can be locked or opened with a mechanical lock, the key to which is, for example, in the possession of the individual recipients or group of recipients, as well as the delivery agent. Some compartments 119, 122, for example, can be electrically unlocked or opened individually and under program control, for example, by a lock control unit provided in the first apparatus 100. In some of these exemplary embodiments, at least one compartment 122 of these compartments may also be configured for accepting parcel shipments. Parcel shipments are, for example, non-letter shipments, such as shipments with dimensions and/or weight that do not meet the criteria for letter shipments. In the present exemplary embodiment, there are both compartments 118, which can be unlocked mechanically, and compartments 119, 122, which can be unlocked under program control. In other exemplary embodiments, compartments 119, 122 unlockable by program control may not be present, or mechanically unlockable compartments 118 may not be present.

In exemplary embodiments in which the received shipment is a letter shipment, the first apparatus 100 may further comprise a compartment 120 with multiple compartments, of which at least some compartments 122 are configured for accepting parcel shipments. Each of these compartments 122 of the compartment system 120 is then configured, for example, to accept one or more parcel shipments and/or one or more objects, e.g. for an individual recipient. Multiple compartments can also be assigned to an individual recipient. In its initial state, each compartment is locked or closed and can be electrically unlocked or opened individually and under program control, for example, by means of a lock control unit provided in the compartment system 120. An example of such a compartment system 120 is a compartment system according to the known Packstation concept of the applicant.

In exemplary embodiments, the register system 110 may be located in a compartment of the first apparatus 100, for example in a compartment of the compartment system 120 as shown in FIG. 1a. In some of these exemplary embodiments, the compartment can be accessible only to persons who have authenticated themselves to the first apparatus 100. For example, these persons may be persons who wish to input shipments into the first apparatus 100, for example, delivery agents, or persons who wish to collect shipments from the register compartment system 120, for example, the recipients.

For this purpose, the first apparatus 100 may be equipped with one or more communication interface(s) as user interface 117, which comprises/comprise, for example, an interface for wireless communication with a mobile device. A wireless communication connection is based, for example, on optical transmission and/or by means of communication based on electrical, magnetic or electromagnetic signals or fields, in particular near-range communication, e.g. based on Bluetooth, WLAN, ZigBee, NFC and/or RFID.

In other embodiments, however, the first apparatus 100, for example, does not comprise an interface for wireless communication with a mobile device, or such an interface is not usable, for example, at all or only in certain situations, or is not used although it would be usable in principle. For example, data that are present and displayed, for example, on the mobile device, can be communicated by means of a user who enters these data or a portion of these data, for example, by means of an input unit of the user interface 117 (e.g. a keyboard or a touch-sensitive screen with a screen keyboard or a speech recognition module or an optical scanner of the register compartment system 120), on the first apparatus 100 and thus transmits same. Of course, a user can also enter data that are not present and/or displayed on the mobile device, for example. In addition, the first apparatus 100 may, for example, also comprise an output unit as a user interface 117, for example, for displaying information, e.g. via a screen.

In exemplary embodiments in which the first apparatus 100 further comprises a compartment system 120 having multiple compartments (which are configured, for example, at least partially for receiving parcel shipments and/or at least partially for receiving letter shipments), the first apparatus 100 may have a, for example, common user interface 117, via which, for example after successful authentication, both access to one or more of the compartments of the compartment system can be obtained and the input and/or issuing of the shipment can be effected. Such an exemplary embodiment is illustrated in FIG. 1a. In other embodiments, however, the first apparatus 100 comprises, for example, a plurality of user interfaces 117′, 117″, with which it is possible either to access to one or more of the compartments of the compartment system or to cause the shipment to be issued, as shown in FIG. 1b. For example, a user interface 117″ in the compartment system 120 is configured to gain access to the compartments 122 of compartment system 120 and has a user interface 117′ with which the input and/or issue of the letter shipment can be effected.

The first apparatus 100, for example, is also configured for communication with a backend system, which means it has, for example, a communication interface that allows access to the Internet or to another communication network to which the backend system is connected. The first apparatus 100 is thus arranged in particular for remote communication, which means it has, for example, an interface to a cellular mobile communication system, a DSL interface or a local area network (LAN) interface, by means of which it can communicate with the system 100 via the communication connection.

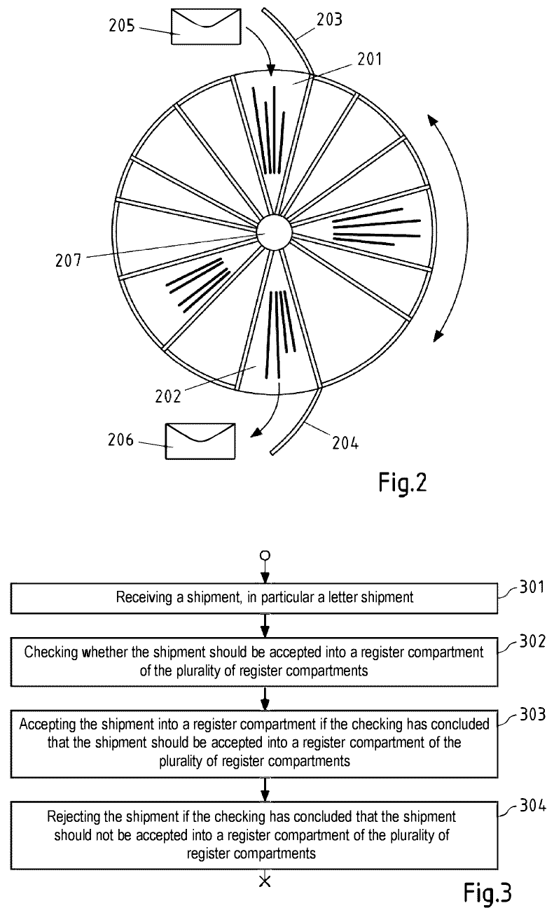

FIG. 3 shows a flowchart 300 of an exemplary embodiment of a method according to the present invention, for example, performed and/or controlled by a first apparatus 100, wherein the first apparatus 100 comprises a plurality of register compartments 111.

In step 301, a shipment, in particular a letter shipment, is received by the first apparatus 100, for example from a person (for example, a delivery agent), who enters the shipment into the first apparatus 100, for example, into an opening in the first apparatus 100 (this opening in the first apparatus 100, for example, is not, however, the register compartment in which the shipment is possibly to be received later). For example, the person places the shipment in the input point 115. In exemplary embodiments, the input point can only be accessible to persons who have successfully authenticated themselves to the first apparatus 100. Access is granted, for example, by opening a flap or by pulling out a drawer. For example, authentication can be effected by transmitting authentication information via the user interface 117 of the first apparatus 100. For example, the person can authenticate themself by entering a user ID and associated password and/or by transmitting authentication information via near-range communication, for example from an app on the person's mobile device or from another authentication object, such as a chip card. The authentication information can then be verified, for example, by the first apparatus 100 itself, for example, by comparing the transmitted authentication information against the authentication information stored (at least temporarily) in the first apparatus 100. In addition or alternatively, the transmitted authentication information can be forwarded to the backend system for verification there and then the result of the authentication transmitted from the backend system to the first apparatus 100.

In step 302, a check is made as to whether the received shipment should be accepted into a register compartment of the plurality of register compartments 111. In exemplary embodiments, the checking can be carried out in response to receiving the shipment or after receiving the shipment. For example, after information has been received via the user interface 117 that one or more shipments have been entered, for example, placed into the first apparatus 100. Alternatively or additionally, the first apparatus 100 can detect the receipt of a shipment (or multiple shipments), for example by means of sensors. Depending on the result of the checking in step 302, the shipment is then accepted into a register compartment in step 303 or rejected in step 304.

Preferably, in step 303 the received shipment is accepted into a register compartment that does not yet contain any shipments for another recipient. If the recipient of the received shipment already has shipments in one or more register compartments, the received shipment is preferably accepted into one of these register compartments.

The rejecting of a received shipment in step 304 can be effected, for example, by ejecting or outputting the shipment, or by notifying the person who entered the shipments to remove the shipment again. For example, the outputting can only occur after the person has authenticated themself, ensuring that no unauthorized person gains access to the shipments. In the exemplary embodiments in which the first apparatus 100 comprises additional compartments 118, 119, 122, after the rejection of the received shipment, for example, information can be provided to the person that the shipment is to be accepted into one of the compartments 118, 119, 122. For this purpose, the compartment can be unlocked electronically, for example, by the first apparatus 100 or opened mechanically by the person. In the exemplary embodiments in which the first apparatus 100 does not comprise additional compartments 118, 119, 122, the shipments may, for example, be taken away by the person and otherwise delivered to the recipient (for example, in their letterbox).

In exemplary embodiments, the checking in step 302 may be based, for example, at least on a property or piece of information of the shipment. The property or piece of information of the shipment may include, for example, the recipient, the recipient's address and/or all or individual dimensions (length and/or width and/or depth and/or weight), i.e. the size of the shipment. For example, the first apparatus 100 may be configured to accept only shipments for certain recipient addresses, for example, within a certain radius around the location of the first apparatus 100, or for certain recipients who have previously registered, for example, with the operator of the first apparatus 100. For example, a shipment can be alternatively or additionally rejected if the recipient is already assigned a compartment 118, 119, 122 and the shipment is therefore to be accepted into the assigned compartment and not in a register compartment 111. The compartments 118, 119, 122 can be permanently assigned to a recipient, for example by the recipient renting them from the operator of the first apparatus 100 (e.g. as in a conventional mailbox). This is preferably the case for the compartments 118 with a mechanical lock, the keys to which are available to the recipient. The compartments 119, 122 with an electronically unlockable lock can preferably be occupied dynamically and are assigned to a recipient only for as long as the compartment 119, 122 contains a shipment for that recipient. Alternatively or in addition, the first apparatus 100 may, for example, receive a list of shipments to be accepted, for example from the backend system, so that only these shipments will be received. Alternatively or in addition, the first apparatus 100 may be configured to accept only shipments with certain sizes or shipments up to a maximum size. The size can be determined by, for example, the length, width, depth or the weight of the shipment or any combination thereof. In some of these exemplary embodiments, the property or piece of information of the shipment can be automatically detected upon receipt of the shipment, for example by the first apparatus 100, the register system 110 or another component of the first apparatus 100. The detection takes place, for example, by reading a barcode, a data matrix code (DMC), a Quick Response (QR) code, a radio frequency identification (RFID) transponder or information in plain text. The read-out information can already contain the property or information, for example, but alternatively, it can also contain, for example, only a shipment identification which can be linked to the required property or information by comparing it against stored data. The stored data may have been captured, for example, during processing of the shipment before delivery and transmitted to the first apparatus 100. Alternatively, the stored data may have been stored in the backend system. In this case, the first apparatus 100 can transmit the shipment identification to the backend system and then receive the required property or piece of information back from the backend system. Alternatively or in addition, the property or piece of information may have been captured, for example, by scanning and measuring the shipment and/or weighing the shipment in the register compartment system 120. Alternatively or in addition, the property or piece of information can be obtained via the user interface 117, for example from the person who entered the shipment.

In exemplary embodiments, the checking in step 302 may alternatively or additionally be based on the current and/or forecast utilization of the first apparatus 100. For example, a shipment can be rejected if all register compartments are already occupied or are forecast to be occupied in the future (for example, due to one or more pre-reserved register compartments). Alternatively or in addition, a shipment can be rejected, for example, if one or more shipments for the recipient have already been accepted into a register compartment and the further shipment would exceed the capacity of the register compartment (for example, by the total depth (or another dimension) of the shipments exceeding a stipulated maximum depth (or another dimension) of the register compartment or the register system 110, the total weight exceeding a stipulated maximum weight, or the total number of shipments exceeding a stipulated maximum number of the register compartment). In exemplary embodiments, the checking in step 302 can further comprise checking whether one or more shipments already accepted into one or more register compartments 111 of the register system 110 are to be issued. If, for example, a shipment is rejected and is instead to be accepted into one of the compartments 118, 119, 122 of the first apparatus 100, further shipments already accepted into one or more register compartments 111 of the register system 110 with the same recipient are preferably output, for example together with the rejected shipment. This means that all shipments intended for the same recipient can be accepted into the same compartment (e.g. 118, 119, 122) and the register compartment can accept other shipments. For this purpose, in exemplary embodiments the register system 110 is configured, at the rejecting of the shipment, to issue one or more further shipments already accepted into one or more register compartments 111 of the register system 110, for example together with the rejected shipment. Alternatively or additionally, for example, all shipments of one or more selected register compartments 111 can be issued instead of rejecting the received shipment, if the shipment would be rejected, for example, due to the utilization level. For example, the number or size of the shipments in the register compartment can be used to select the register compartment from which the shipments are issued. For example, the shipments are output from the register compartment that contains the most shipments or shipments with the largest overall size. Alternatively or additionally, for example, all shipments of one or more selected register compartments can be output if it is determined that one of the compartments 118, 119, 122 of the first apparatus 100 is assigned to the recipient of the shipments.

In exemplary embodiments, the first apparatus 100 is configured to receive multiple shipments at once in step 301 and to perform the checking in step 302 for each of the multiple shipments sequentially. Furthermore, the first apparatus 100 is configured, for example, to perform the accepting or rejecting for each of the multiple shipments according to the result of the checking. The accepting or rejecting does not necessarily need to be carried out sequentially, but can also be carried out for more than one of the multiple shipments at once.

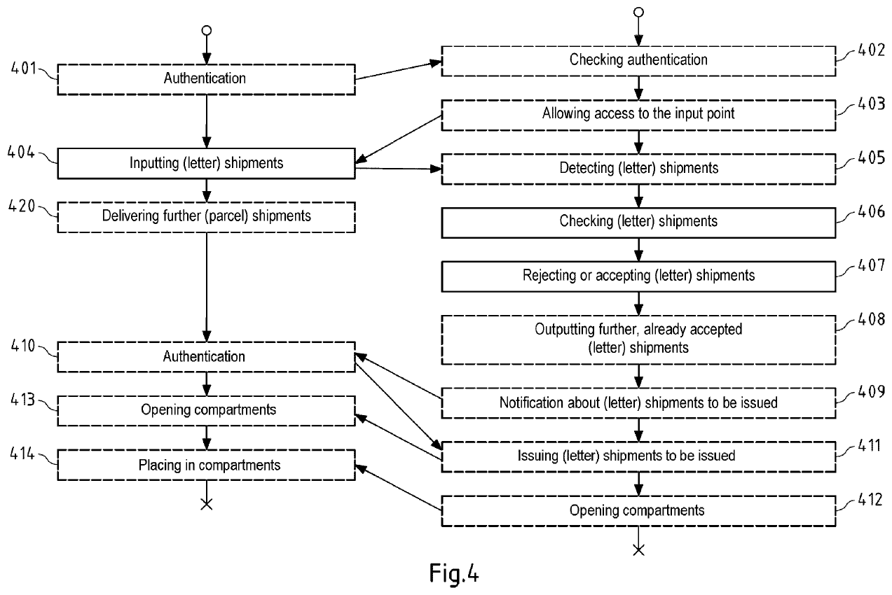

FIG. 4 is a flowchart of an exemplary embodiment of a method according to the present invention with a detailed illustration of individual steps. Optional steps for this exemplary embodiment are shown in dashed lines.

In step 401, the delivery agent authenticates themself to the first apparatus 100 for entering shipments. For example, the agent uses an app running on their mobile device, such as a smartphone or handheld scanner. For this purpose, for example, the mobile device directs a request to the first apparatus 100 for establishing a near-range data communication connection, such as optical transmission, Bluetooth, ZigBee, NFC, RFID or WLAN. Subsequently, authentication information, preferably encrypted, is transmitted from the mobile device to the first apparatus 100. This information is checked by the first apparatus 100 in step 402. This takes place, for example, in the first apparatus 100 itself or in a backend system connected to it via a remote data communication connection. Alternatively, the authentication information may also be stored, for example, in an authentication object, such as an NFC chip or RFID token, or, for example, may also be entered on the first apparatus 100 by the delivery agent, for example in the form of a user ID and an associated password.

In the event of successful authentication, the delivery agent is given access to the input point 115 in step 403. For example, by opening the compartment in which the register system 110 is located, by opening a flap of the input point or by pulling out a drawer. In step 404, the delivery agent then enters shipments, for example, a stack of letter shipments—as a not necessarily limiting example of shipments for this exemplary embodiment—into the input point 115, for example, one or more standard, compact, large and/or maxi letters and/or one or more book shipments and/or one or more flat packages. Then the delivery agent can confirm that the letter shipments have been entered, for example by confirming it in the app on their mobile device, confirming it on the user interface 117 or, for example, by closing the flap of the input point or closing the drawer.

After receiving the letter shipments, the first apparatus 100 detects the individual letter shipments in step 405. For example, it detects the recipient, the recipient's address, the dimensions and/or the weight of the letter shipment. Then, in step 406, the first apparatus checks sequentially for each letter shipment received whether it should be accepted into a register compartment. Step 405 and step 406 can be performed sequentially for each individual letter shipment; alternatively, step 405 can be executed for all letter shipments first and only then can step 406 be started; alternatively, steps 405 and 406 can be performed sequentially for the letter shipments of one recipient and then step 405 can be started for another recipient.

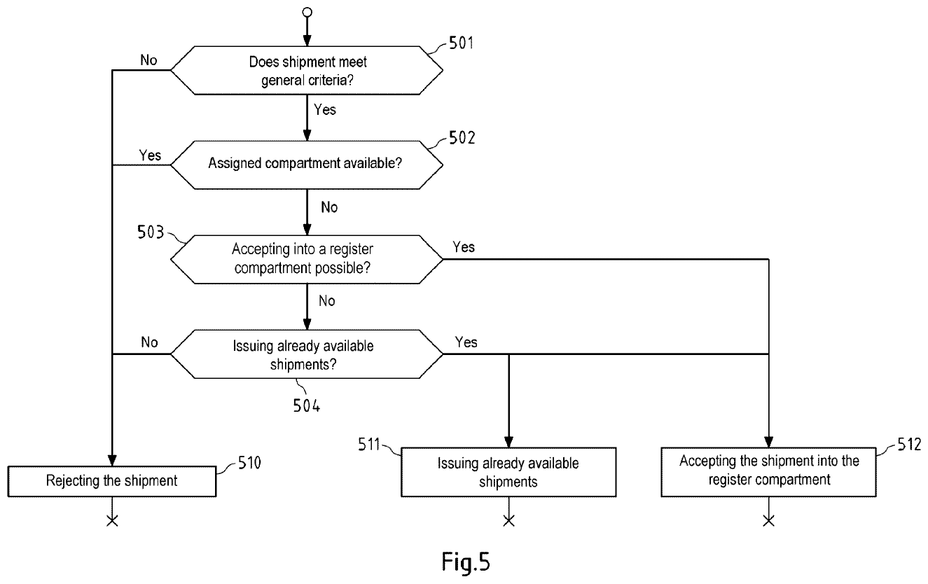

FIG. 5 is a flowchart of an exemplary embodiment of such a checking in step 406 (again based on the non-limiting example of a letter shipment as the shipment) and of the steps 407, i.e. the rejecting or accepting of the letter shipment, and 408, i.e. the issuing of further already accepted shipments. The checking in step 406 may, for example, contain all, (only) some or only one of the checking step(s) 501-504 of the embodiment shown in FIG. 5. In embodiments in which step 406 does not include all checking steps 501-504 shown in FIG. 5, for example, one or more of these checking steps can be carried out outside of the first apparatus 100 in an upstream process (for example, steps 501 and/or 502), so that the first apparatus 100 only receives, for example, such shipments for which the upstream check has concluded that it is possible in principle for them to be accepted into a register compartment—but depending on the result of the further checking steps (i.e., for example, step 501 has resulted in a “Yes” or step 502 has resulted in a “No”). The checking in step 406 then relates to those checking steps that have not yet been checked in the upstream process.

For example, in step 501 it is first checked whether the letter shipment meets the general criteria for accepting a shipment. This checking in step 501 may comprise, for example, whether the recipient is registered for receiving shipments on the first apparatus 100. Alternatively or in addition, the checking in step 501 can comprise whether the recipient address corresponds to an address for which shipments are to be accepted. In addition, in step 501, it can be checked, for example, whether the dimensions of the letter shipment allow it to be accepted by a register compartment, i.e. whether the shipment is not too long, wide, deep and/or heavy to fit into a register compartment. If the shipment does not meet the general criteria, the shipment is rejected (step 510). Otherwise, in step 502, it is checked, for example, whether one of the compartments 118, 119, 122 is already assigned to the recipient, for example because one of the compartments 122 contains a parcel shipment for the recipient or because the recipient has rented a permanently assigned compartment 118, 119, 122. For example, if one of compartments 118, 119, 122 is already assigned to the recipient, the shipment is rejected (step 510). Otherwise, in step 503 it is checked whether the shipment can be accepted into one of the register compartments 111.

For example, in step 503 it is first checked whether there is already a register compartment with shipments for the same recipient. In this case, the letter shipment is preferably accepted into the same register compartment. For this purpose, it can be additionally checked, for example, whether the capacity of the register compartment or the register system 110 will be exceeded by accepting the letter shipments, for example the maximum number of shipments, the maximum total depth of the shipments and/or the maximum total weight of the shipments. If this is not the case, the shipment is accepted into the register compartment. Otherwise, for example, the shipment can be rejected or alternatively it can be checked whether the shipment can or should be accepted into another empty register compartment. A check of whether the shipment can or should be accepted into an empty register compartment is also carried out, for example, if there is still no register compartment with shipments for the same recipient. The checking is based, for example, on the (current or forecast) utilization of the register system 110. If the result is positive, the letter shipment is accordingly accepted into an empty register compartment (step 512).

If the result of the checking in step 503 is negative, for example, in step 504 it can be checked whether, instead of rejecting the letter shipment, one of the register compartments 111 should be emptied, i.e. all the shipments of this register compartment should be issued. Under defined preconditions, issuing multiple shipments of a register compartment may be preferable to rejecting a single letter shipment. For example, if the maximum number of letter shipments for the register system 110 is the limiting criterion of the utilization, since after issuing the multiple shipments further letter shipments can subsequently be accepted into the register system 110 and only one compartment 119, 122 of the first apparatus 100 is blocked by the multiple shipments issued from the register compartment, instead of occupying multiple compartments 119, 122 of the first apparatus 100 with individual shipments. In this case, these shipments are issued (step 511) and the received letter shipment is accepted into a register compartment (step 512). Otherwise, the letter shipment will be definitively rejected (step 510).

Turning attention again to FIG. 4, as has already been explained by way of example with reference to FIG. 5, in step 407 according to the result of the checking from step 406, the letter shipment is either accepted into one of the register compartments 111 or the letter shipment is rejected. At the rejecting of a letter shipment, similar to step 511 in FIG. 5, for example in step 408 further shipments already accepted into one or more register compartments 111 of the register system 110 can be issued, preferably the shipments that have the same recipient as a rejected shipment. For example, step 408 can be carried out after all letter shipments have been checked in step 406, or for example each time the checking in step 406 has concluded that a letter shipment is rejected.

At the rejecting of the letter shipment, the letter shipment can be issued, for example, at the output point 116. For example, the issuing can take place sequentially at the rejecting of the letter shipment, or collectively for all letter shipments that are to be issued after the checking in step 406 has been completed for all letter shipments. For this purpose, the first apparatus 100 can comprise, for example, a temporary repository in which rejected letter shipments are stored. The output point 116, similar to the input point 115, can be configured with an access restriction, so that a user receives access to it, for example, only after (re)authentication. For this purpose, the first apparatus 100 can communicate, for example in step 409, to the delivery agent via the user interface 117, that some of the letter shipments have been rejected and must be removed. During the processing of the received letter shipments by the first apparatus 100 in steps 405-409, the delivery agent can, for example, input other shipments that are not intended to be accepted into register compartments, for example, parcel shipments, into the first apparatus 100 (step 420). Subsequently, in step 410, the delivery agent can communicate to the first apparatus 100, for example, via the app of their mobile device or an input on the user interface 117, that they are ready to accept the letter shipments to be issued and can, for example, re-authenticate themself, for example according to step 401. After successful authentication, the first apparatus 100 in step 411 can issue all shipments to be issued or allow access to the issuing point 116.

In step 412, the first apparatus 100 opens, for example, all compartments 119, 122 (if present), which can be electronically unlocked and into which the letter shipments issued in step 411 are to be placed. For example, the compartments 118 that can be manually unlocked (if present) can be opened by the delivery agent themself in step 413. The delivery agent then places the letter shipments issued in step 411 in the open compartments and then locks or closes them again. For this purpose, the first apparatus 100 can output, for example, via the user interface 117, information to the delivery agent as to which letter shipments are to be entered into which compartment. Alternatively, the delivery agent can start a new process by requesting a compartment on the first apparatus 100 and indicating which letter shipments they will place there. Preferably, all the letter shipments of a recipient are entered into one compartment. For example, the issuing of the letter shipments in step 411 and the opening of the compartments 118, 119, 122 in step 412 and 413 can be carried out jointly for all letter shipments. Alternatively, for example, all letter shipments of a recipient are output first and a single compartment is opened into which these letter shipments are placed. Then, all letter shipments of the next recipient are issued and the next compartment is opened. After all issued letter shipments to be placed in the compartments 118, 119, 122 have been placed into the compartments by the delivery agent in step 414, the delivery process is completed. In the exemplary embodiments in which the first apparatus 100 does not comprise additional compartments 118, 119, 122, or if insufficient compartments 118, 119, 122 are available, the shipments can, for example, be taken away by the delivery agent and otherwise delivered to the recipient (for example, by delivery to their letterbox).

In exemplary embodiments, the method may further comprise issuing the shipment to a person who has successfully authenticated themself to the first apparatus 100. For example, for collecting of a letter shipment, a person first authenticates themself to the first apparatus 100 to the effect that they are entitled to take receipt of the letter shipments. Similarly to step 401, the authentication can be effected by transmitting authentication information, for example, via an app, an authentication object, or by entering a user ID. On the basis of the transmitted authentication information, the first apparatus 100 can determine the letter shipments that the person is authorized to receive. If such letter shipments have been accepted into the register system 110, they are issued from the registry system 110 after successful authentication and the person is granted access to the output point 116 by the first apparatus 100, for example by opening a flap, opening the compartment in which the register system 110 is located and/or pulling out a drawer. If it has been determined by the first apparatus 100 that letter shipments and/or further shipments for the person are present in one of the compartments of the first apparatus 100, the first apparatus 100 can issue a message to the person, for example via the user interface 117, that additional shipments should be removed from the compartments. For compartments with a mechanical lock 118 (if present), for example, the person can open them with their key. For locks 119, 122 that can be unlocked electronically (if present), the first apparatus 100 can unlock them, for example, in the same step or after a re-authentication.

The steps of FIG. 4 and FIG. 5 do not necessarily have to be performed in the described sequence and can, provided no mandatory logical sequence exists, be interchanged with one another; also the steps can be carried out partially in parallel with one another.

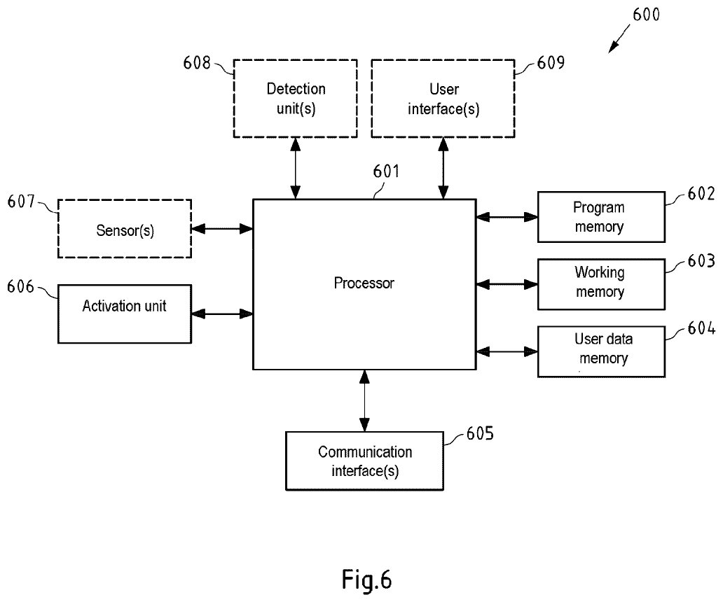

FIG. 6 shows a schematic illustration of an exemplary embodiment of an apparatus according to the invention, for example, a first apparatus 100 or the control unit thereof. Here, optional components for this exemplary embodiment are shown in dashed lines.

The apparatus 600 comprises a processor 601, a program memory 602, a working memory 603, a user data memory 604, one or more communication interface(s) 605, an activation unit 606, one or more optional sensors 607, one or more optional detection unit(s) 608 and one or more optional input unit(s) 609. The processor 601 executes, for example, a program according to the invention, which is stored in the program memory 602, for example as firmware. The working memory 603 is used in particular to store temporary data during the execution of this program. The user data memory 604 is used to store data that are required when the program is executed.

The communication interface(s) 605 comprise/comprises, for example, an interface for wireless communication with a mobile device, for example by means of optical transmission and/or by means of communication based on electrical, magnetic or electromagnetic signals or fields, in particular on Bluetooth, NFC and/or RFID (radio frequency identification). In some embodiments, the apparatus 600 is, for example, additionally configured for direct communication with a backend system, which means it has, for example, a communication interface that allows access to the Internet or to another network to which the backend system is connected.

The activation unit 606 allows, for example, a shipment to be accepted into a specific register compartment, in particular by activating the motors and/or gears. However, the activation unit also allows, for example, a single compartment 119, 122 of the first apparatus 100 to be opened or unlocked in a targeted manner in order to enable the opening, in particular by actuating the lock of the compartment 119, 122 or a lock control unit of the compartment 119, 122.

The sensors 607 enable, for example, detection of whether shipments have been placed in the input point 115 and/or whether shipments have been removed from the output point 116. For example, they also allow detection of whether a particular shipment or a particular object is located in a particular compartment 118, 119, 122 and/or whether the door of a compartment 118, 119, 122 is open or closed.

The detection unit(s) 608, for example, allows/allow the automatic detection of the property or information of the shipment which forms the basis of the checking 406 as to whether the shipment is to be accepted into a register compartment. In an exemplary embodiment it is a scanner that can optically capture information (alternatively, for example, RFID technology can be used).

The user interface(s) 609 is/are configured to communicate with a user. A user interface can comprise, for example, an output unit for displaying (e.g. via a screen or via compartment-specific light displays (e.g. for indicating a particular state occupied/unoccupied)) or acoustically outputting information and/or an input unit for obtaining information and/or data (e.g. a keyboard or a touch-sensitive screen with a screen keyboard or a speech recognition module) from the persons. Preferably, however, no input unit/output unit is provided and the user communicates with the first apparatus 100 only via a mobile device, for example, to reduce the associated maintenance and/or repair outlay (e.g. due to vandalism) and/or the manufacturing costs. The user interface (for example, comprising the menu navigation) of the first apparatus 100 is then, for example at least partially or completely, outsourced to the mobile device.

The illustrative embodiments / exemplary embodiments of the present invention described in this specification shall also be understood in all combinations with one another. In particular, the description of a feature comprised by an embodiment - unless explicitly stated to the contrary - is also not to be understood in the present case in such a way that the feature is indispensable or essential to the function of the exemplary embodiment.

The sequence of the method steps described in this specification in the individual flow diagrams is not mandatory; alternative sequences of the method steps are conceivable. The method steps can be implemented in different ways, thus an implementation in software (by program instructions), hardware or a combination of both is conceivable for the implementation of the method steps. Terms used in the claims, such as “comprise”, “exhibit”, “include”, “contain” and the like, do not exclude other elements or steps. The wording “at least partially” includes both the “partial” case and “complete” case. The wording “and/or” shall be understood to mean that both the alternative and the combination shall be disclosed, i.e. “A and/or B” means “(A) or (B) or (A and B)”. A plurality of units, persons or the like in connection with this specification means multiple units, persons or the like. The use of the indefinite article does not exclude a plurality. A single system can perform the functions of multiple units or systems specified in the claims. The reference signs specified in the claims are not to be regarded as limitations on the means and steps used.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. Method, performed by a first apparatus or by a component thereof, wherein the first apparatus comprises a plurality of register compartments, the method comprising:
receiving a shipment, in particular a letter shipment;
checking whether the shipment is to be accepted into a register compartment of the plurality of register compartments;
accepting the shipment into a register compartment if the checking has concluded that the shipment is to be accepted into a register compartment of the plurality of register compartments; and
rejecting the shipment if the checking has concluded that the shipment should not be accepted into a register compartment of the plurality of register compartments.

2. Method according to claim 1, further comprising:
issuing the shipment to a person who has successfully authenticated themself to the first apparatus.

3. Method according to claim 1, wherein the checking is based at least on a property or information of the shipment.

4. Method according to claim 3, wherein the property of the shipment is automatically captured at the receiving of the shipment.

5. Method according to claim 1, wherein the checking is based at least on the current or predicted utilization of the first apparatus.

6. Method according to claim 1, wherein the checking further comprises checking whether one or more shipments already accepted into one or more register compartments of the register system are to be issued.

7. Method according claim 1, wherein the checking is carried out in response to receiving the shipment or after receiving the shipment.

8. Method according to claim 1, wherein at least one register compartment of the plurality of register compartments is configured to store multiple shipments simultaneously, in particular multiple shipments associated with the same recipient.

9. Method according claim 1, wherein the plurality of register compartments are part of a register system of the first apparatus.

10. Method according to claim 9, wherein the register system is configured to carry out the accepting of the shipment in the register compartment of the shipment.

11. Method according to claim 9, wherein the register system is configured, at the rejecting of the shipment, to issue one or more further shipments already accepted into one or more register compartments of the register system.

12. Method according to claim 9, wherein the plurality of the register compartments are arranged to be movable in the register system, in particular rotatable about an axis.

13. Method according to claim 9, wherein the plurality of the register compartments in the register system are movable along a closed, in particular oval trajectory.

14. Method according to claim 1, wherein the shipment is a letter shipment, and wherein the first apparatus further comprises multiple compartments, at least some of which are configured for receiving letter shipments.

15. Method according to claim 14, wherein at least one compartment is additionally configured for receiving parcel shipments.

16. Method according to claim 14, wherein the plurality of register compartments are part of a register system of the first apparatus, and wherein the register system is located in a compartment of the first apparatus.

17. Method according to claim 16, wherein the compartment is accessible only to persons who have authenticated themselves to the first apparatus.

18. Method according to claim 1, wherein the first apparatus is configured to receive multiple shipments at once and to perform the checking sequentially for each of the multiple shipments.

19. Method according to claim 1, wherein at least one of the register compartments is configured to change its size.

20. Method according to claim 1, wherein at least one of the register compartments has a storage size and an input size, wherein for inputting a shipment into the at least one register compartment and/or outputting a shipment from the at least one register compartment, the register compartment is enlarged from the storage size to the input size and is reduced to the storage size again after the inputting and/or outputting.

21. Method according to claim 1, wherein the shipment is a letter shipment, and wherein the first apparatus further comprises a compartment system having multiple compartments, of which at least some compartments are configured for accepting parcel shipments.

22. Method according to claim 21, further comprising issuing the shipment to a person who has successfully authenticated themself to the first apparatus, wherein the first apparatus has a user interface, by means of which both access to one or more of the compartments of the compartment system can be obtained and the issuing of the shipment can be caused.

23. Apparatus comprising at least one processor and at least one memory which comprises program code, wherein the memory and the program code are configured to cause a or the apparatus having the at least one processor to at least perform and/or to control the method according to claim 1, wherein the apparatus is the first apparatus or the component thereof.

24. Apparatus according to claim 23, wherein the plurality of register compartments are part of a register system of the first apparatus, the apparatus further comprising the register system.

25. Use of an apparatus according to claim 23, to deposit a shipment for a person and to enable the person to obtain access to that shipment.

26. A computer-readable storage medium having stored thereon a computer program, comprising program instructions that cause a processor to execute and/or control at least the following steps when the computer program is running on the processor:
receiving a shipment, in particular a letter shipment, on a first apparatus that comprises a plurality of register compartments;
checking whether the shipment is to be accepted into a register compartment of the plurality of register compartments;
accepting the shipment into a register compartment if the checking has concluded that the shipment is to be accepted into a register compartment of the plurality of register compartments; and
rejecting the shipment if the checking has concluded that the shipment should not be accepted into a register compartment of the plurality of register compartments.
